(19) United States
(12) Patent Application Publication
(10) Pub. No.: US 2014/0190440 A1
(43) Pub. Date: Jul. 10, 2014

(54) RECOIL STARTER

(71) Applicant: Hiroki Kato, Tokyo (JP)

(72) Inventor: Hiroki Kato, Tokyo (JP)

(21) Appl. No.: 14/144,815

(22) Filed: Dec. 31, 2013

(30) Foreign Application Priority Data
Jan. 7, 2013 (JP) 2013-000316

(51) Int. Cl. F02N 3/02

(52) U.S. Cl. CPC F02N 3/02
USPC 123/185.3

(57) ABSTRACT

A recoil starter exemplified in the embodiment includes: a starter case; a rope reel; a recoil rope; a ratchet; and a drive pulley. When the rope reel is rotated by pulling the recoil rope, the ratchet pivots to engage an engaged unit of the drive pulley to thereby transmit a torque of the rope reel to an engine. The rope reel has: a ratchet receiving unit; and a reinforcing unit. The ratchet receiving unit is arranged to receive a front end portion of the ratchet when it is engaged with the engaged unit of the drive pulley. And, the reinforcing unit extends in a circumferential direction of the rope reel with respect to the ratchet receiving unit as its leg portion.

### CROSS-REFERENCE TO RELATED APPLICATION(S)

This application claims priority/priorities from Japanese Patent Application No. 2013-000316 filed on Jan. 7, 2013, the entire contents of which are herein incorporated by reference.

### FIELD

The present invention relates to a recoil starter in which a torque of a rope reel generated by pulling a recoil rope is transmitted to a drive pulley connected to a crankshaft of an engine through a ratchet mechanism to thereby start the engine.

### BACKGROUND

A recoil starter may have a ratchet mechanism configured to cause a rope reel to engage or disengage with a drive pulley, so that the rotation of the rope reel is transmitted to an engine upon pulling of the recoil rope but the rotation of the engine is not transmitted to the rope reel after the engine starts.

As such ratchet mechanism, a ratchet may be provided on the rope reel. In this case, since the rope reel is required to receive the load applied to the ratchet, the rope reel needs to have a sufficient rigidity. If the rigidity of the rope reel is not sufficient, the rope reel may be deformed, and thus, the ratchet may come off.

In view of above, for example, JP-2004-124825-A discloses the technique to provide a recoil starter with a sufficient strength without increasing the thickness of a rope reel. JP-2004-124825-A proposes to form a supporting hole for pivotably supporting a ratchet member as a completely circular hole so that the strength of the periphery of the supporting hole can be sufficiently secured, and to provide a receiving member for receiving an end portion of an arm unit of the ratchet member.

On the other hand, a high rigid material such as a glass reinforcing material (e.g., a glass-fiber reinforced resin) has been conventionally used in order to secure the strength of the rope reel. However, such high rigid material is generally expensive, thereby increasing the manufacturing cost. In other words, if it is possible to realize the sufficient strength in terms of a structure by even using a low rigid material, a material cost can be reduced.

### SUMMARY

One object of the present invention is to provide a recoil starter capable of preventing deformation of a rope reel even when the rope reel is made from a low rigid material to thereby reduce the manufacturing cost.

The present invention provides following Aspects 1 to 4.

Aspect 1 provides
a recoil starter including:
a starter case (11);
a rope reel (12) attached rotatable to the starter case (11);
a recoil rope (13) wound around the rope reel (12);
a ratchet (14) pivotably attached to the rope reel (12); and
a drive pulley (15) connected to an engine, the drive pulley (15) having an engaged unit (15a) engageable with the ratchet (14),
wherein, when the rope reel is rotated by pulling the recoil rope (13), the ratchet (14) pivots to engage the engaged unit (15a) of the drive pulley (15) to thereby transmit a torque of the rope reel (12) to an engine, and
wherein the rope reel (12) has:
a ratchet receiving unit (12c) arranged to receive a front end portion (14b) of the ratchet (14) when it is engaged with the engaged unit (15a) of the drive pulley (15); and
a reinforcing unit (12d) that extends in a circumferential direction of the rope reel (12) with respect to the ratchet receiving unit as its leg portion.

Aspect 2 provides
the recoil starter of Aspect 1,
wherein the reinforcing unit (12d) is formed to cover the front end portion (14b) of the ratchet (14) when it contacts the ratchet receiving unit (12c) and to thereby suppress floating of the front end portion (14b) of the ratchet (14).

Aspect 2 provides
the recoil starter of Aspect 1,
wherein two ratchet receiving units (12c, 12c) are provided as the ratchet receiving unit (12c) in a line symmetry manner with respect to the reinforcing unit (12d).

Aspect 4 provides
the recoil starter of Aspect 3, further including: a control member (18) attached to the starter case (11) concentrically with the rope reel (12),
wherein the ratchet (14) has a projection (14c), and the control member (18) has an engaging groove (18a) which receives the projection (14c) and which extends to guide a pivoting movement of the ratchet (14) to project radial outward, and
wherein two engaging grooves (18a) are provided as the engaging groove (18a) in a line symmetry manner.

According to Aspect 1, the rope reel includes the ratchet receiving unit arranged to receive the front end portion of the ratchet engaging the engaged unit of the drive pulley, and the reinforcing unit that extends in the circumferential direction with respect to the ratchet receiving unit as its leg portion. Thus, the reinforcing unit reinforces the ratchet receiving unit on which a load is applied, thereby preventing deformation of the rope reel. Since the reinforcing unit is formed continuously with the ratchet receiving unit, the rope reel can be structurally simplified and can be reduced in weight.

According to Aspect 2, since the reinforcing unit is formed to cover the front end portion of the ratchet projecting outward, floating of the front end portion can be suppressed, and the ratchet can be prevented from coming off the ratchet receiving unit even when the rope reel is deformed. Since this effect is achieved by the reinforcing unit, it is unnecessary to provide another member arranged to suppress the floating, thereby simplifying the structure.

According to Aspect 3, since the ratchet receiving units are provided in a line symmetry manner with respect to the reinforcing unit, the present invention can be applied to an engine regardless of its rotation direction by using either one of the ratchet receiving units. Thus, it is unnecessary to manufacture two kinds of rope reels for both rotation directions of engines, thereby reducing the manufacturing cost.

### BRIEF DESCRIPTION OF DRAWINGS

FIG. 1 is a front view of a recoil starter.

FIG. 2 is a cross-sectional view of the recoil starter.

FIG. 3 is a front view of a rope reel.

FIG. 4 is a perspective view of the rope reel.

FIG. 5 is a perspective view of the rope reel and a ratchet attached thereto.

FIG. 6 is a front view of a recoil starter having another ratchet arrangement.

FIGS. 7A and 7B are rear views of a control member.

### DETAILED DESCRIPTION

An embodiment will be described with reference to drawings.

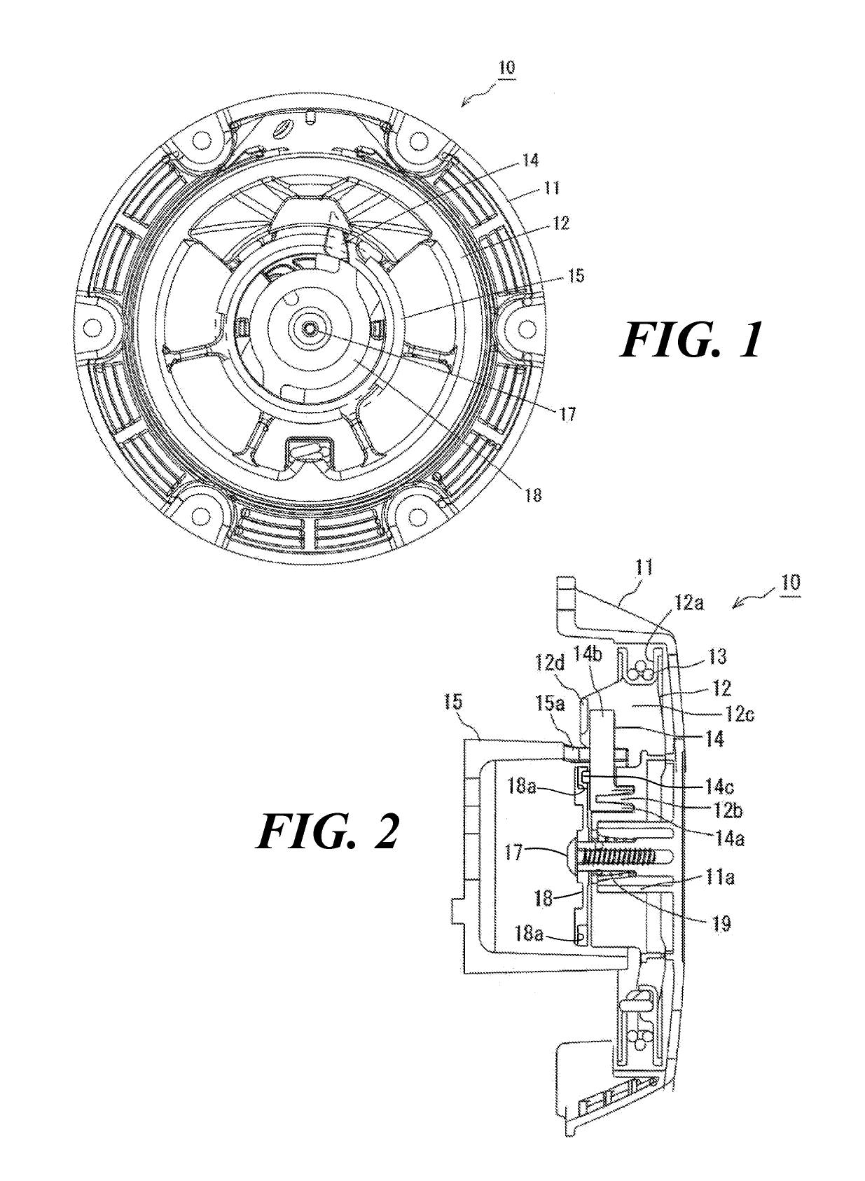

A recoil starter 10 according to the present embodiment includes a starter case 11, a rope reel 12, a recoil rope 13, a ratchet 14 and a drive pulley, as shown in FIGS. 1 and 2. The starter case 11 is formed to accommodate main components of the recoil starter 10 and to cover a rotary unit of an engine. The rope reel 12 is rotatably attached to the starter case 11. The recoil rope 13 is wound around the rope reel 12. The ratchet 14 is pivotably attached to the rope reel 12. The drive pulley 15 includes engagement portion 15a with which the ratchet 14 is engaged.

The starter case 11 has a reel supporting unit 11a that projects toward a crankshaft of the engine, and the rope reel 12 is rotatably attached to the reel supporting unit 11a.

The rope reel 12 has a rope holding groove 12a on an outer periphery thereof so as to be opened radial outward. And, the recoil rope 13 is wound around the rope holding groove 12a, such that one end thereof is fixed to the rope reel 12, and the other end thereof is drawn out of the starter case 11 through an opening (not illustrated) formed therein. Thus, the rope reel 12 rotates upon pulling of the recoil rope 13.

A recoil spiral spring (not illustrated) is disposed between the rope reel 12 and the starter case 11. The recoil spiral spring urges the rope reel 12 in the reverse direction to rewind the recoil rope 13. While one end of the recoil spiral spring is fixed to the rope reel 12, the other end of the recoil spiral spring is fixed to the starter case 11, such that torque is stored in the recoil spiral spring when the recoil rope 13 is pulled to rotate the rope reel 12. Thus, when the recoil rope 13 is released, the rope reel 12 is rotated in the reverse direction by the torque stored in the recoil spiral spring, and the drawn-out recoil rope 13 is rewound into the rope reel 12.

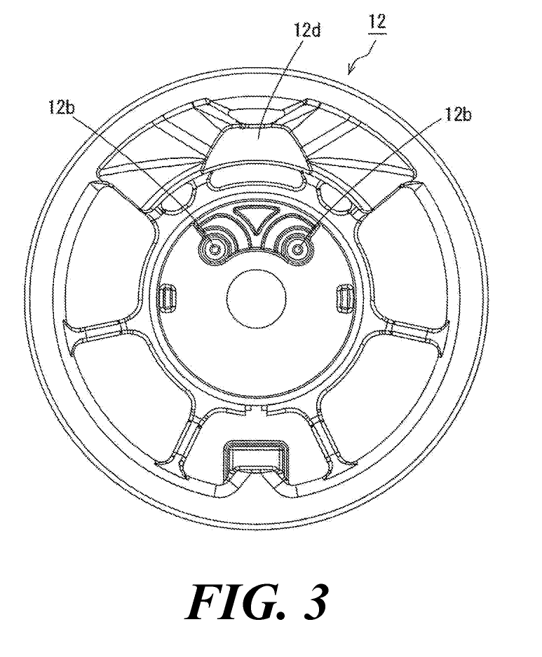

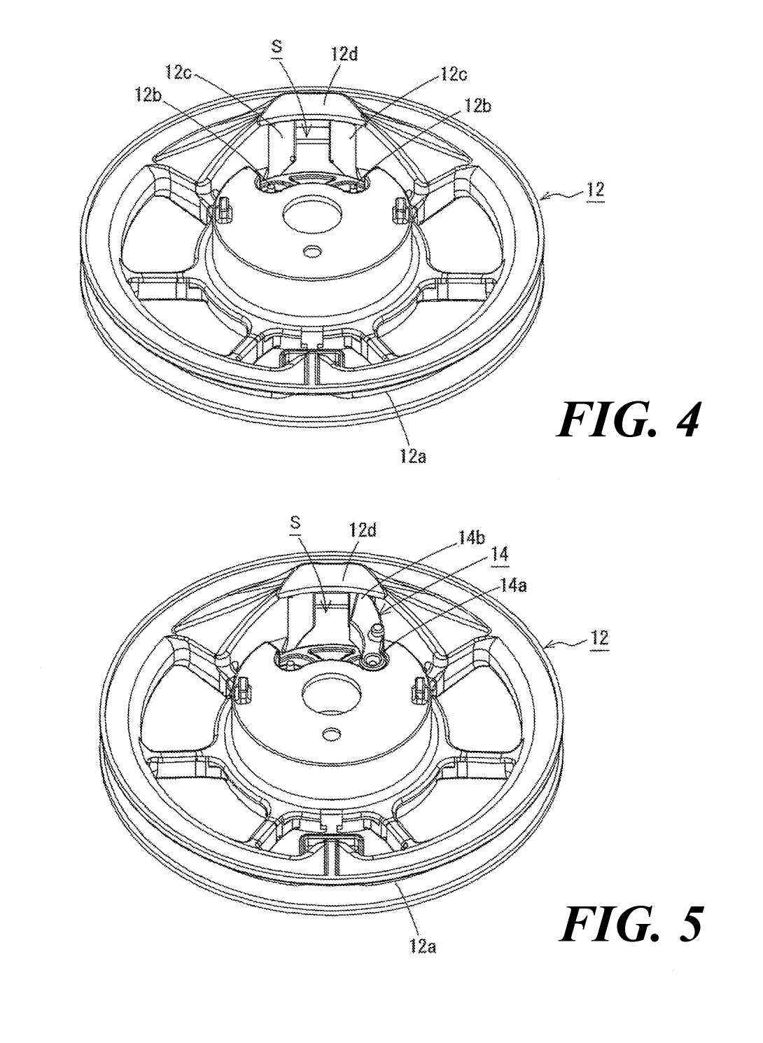

The rope reel 12 further has two ratchet support shafts 12b, two ratchet receiving units 12c and a reinforcing unit 12d, as shown in FIGS. 3 and 4. The two ratchet support shafts 12b project at positions slightly offset from the rotation center, and each of the ratchet support shafts 12b is capable of pivotably supporting the ratchet 14. The two ratchet receiving units 12c facing with each other are positioned more radial outward than the two ratchet support shafts 12b so as to respectively correspond to the two ratchet support shafts 12b. The ratchet receiving units 12c function as the wall units which receive the ratchet 14 having been pivoted. The rope reel 12 is formed in symmetric manner in which the two ratchet support shafts 12b and the two ratchet receiving units 12c face with each other, respectively.

In addition, the reinforcing unit 12d is provided to bridge between the two facing ratchet receiving units 12c.

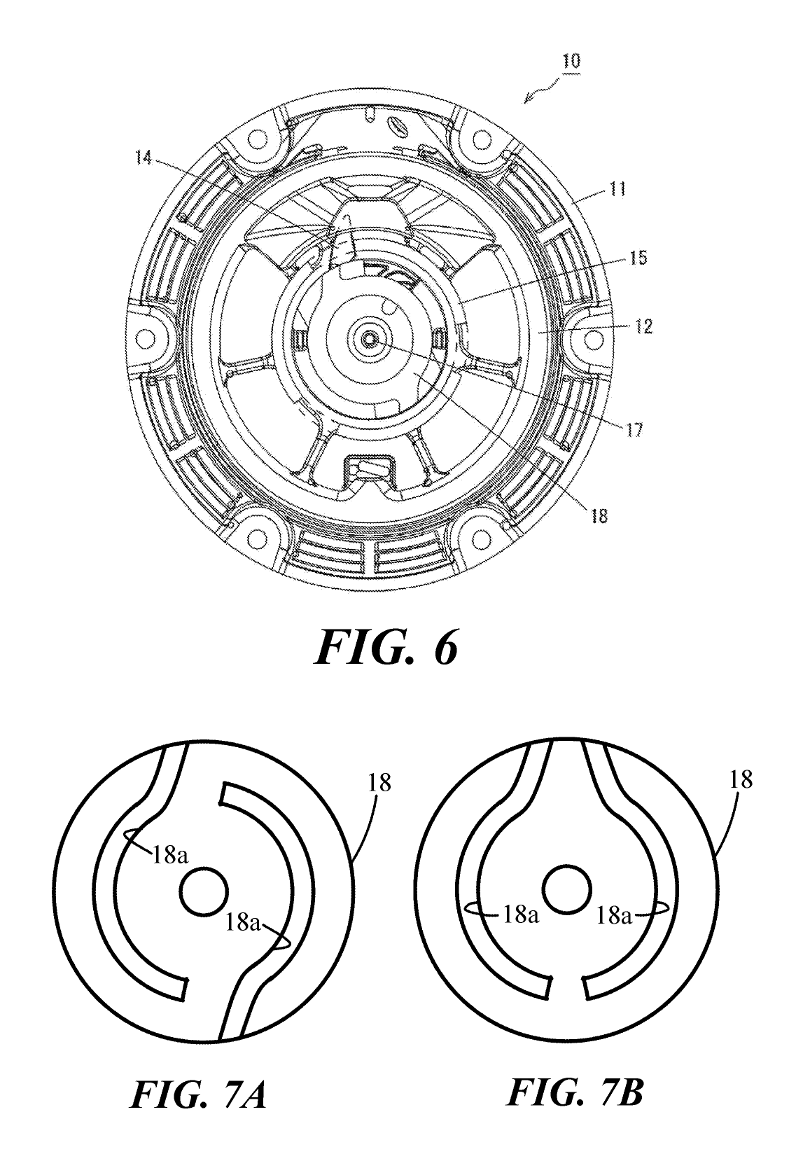

The ratchet 14 has a base portion 14a, a front end portion 14b and a projection 14c. The ratchet 14 is pivotably attached to the rope reel 12 such that the base portion 14a is pivotably fixed to the ratchet support shaft 12b of the rope reel 12, and that the front end portion 14b is projectable outward. The projection 14c is formed on a surface of the ratchet 14. The ratchet 14 is fixed to either of the two ratchet support shafts 12b of the rope reel 12. The ratchet support shaft 12b to which the ratchet 14 is fixed may be determined depending on the rotation direction of the engine. FIG. 1 exemplifies the case where the ratchet 14 is attached on the right-side ratchet support shaft 12b as the rotation direction of the engine is the counterclockwise direction in FIG. 1. The same recoil starter 10 can be applied for an engine which rotates in the reverse direction by attaching a ratchet, which has the mirror-reversed structure, to the other ratchet support shaft 12b as shown in FIG. 6.

The drive pulley 15 functions as a cup-shaped member attached which covers the ratchet support shafts 12b of the rope reel 12 and the ratchet 14 in a retracted position. The drive pulley 15 is attached to the crankshaft of the engine to receive the torque from the rope reel 12. For example, three engagement portions 15a are formed at regular intervals in the circumferential direction on a peripheral wall of the drive pulley 15 as shown in FIG. 1. Thus, the drive pulley 15 is engageable with the ratchet 14 as the front end portion 14b of the ratchet 14 projecting outward is inserted into the engagement portion 15a to be engaged with the peripheral edge of the opening.

A control member 18 is attached to an end face of the reel supporting unit 11a of the starter case 11 with a set screw 17 as shown in FIG. 2, and the rope reel 12 is prevented from coming out of the reel supporting unit 11a by the control member 18.

A friction spring 19 is disposed between the control member 18 and the reel supporting unit 11a so as to produce predetermined friction resistance between the control member 18 and the set screw 17. Thus, the friction resistance is imposed on the rotation of the control member 18.

As shown in FIG. 2, an engaging groove 18a is formed on a surface of the control member 18 so as to receive the projection 14c formed on the surface of the ratchet 14. When the ratchet 14 rotates together with the rope reel 12, the projection 14c is guided along the engaging groove 18a, thereby causing the front end portion 14b of the ratchet 14 to project radial outward. That is, the engaging groove 18a extends to guide the pivoting movement of the ratchet 14 to project radial outward when the ratchet 14 rotates together with the rope reel 12. Although it is sufficient to form one engaging groove 18a in the control member 18, two engaging grooves 18a may be formed. For example, two engaging grooves 18a may be formed in the control member 18 in a point symmetry manner, as shown in FIG. 7A. Alternatively, two engaging grooves 18a may be formed in the control member 18 in a line symmetry manner, as shown in FIG. 7B. If two engaging grooves 18a are formed in the line symmetry manner, the same control member 18 can be used for both of the configuration of FIG. 1 and the configuration of FIG. 6.

As the control member 18 guides the ratchet 14, the front end portion 14b of the ratchet 14 is inserted into the engagement portion 15a of the drive pulley 15 to thereby engage therewith. Further, the front end portion 14b of the ratchet 14 contacts the ratchet receiving unit 12c of the rope reel 12 as shown in FIG. 1.

Next, the operation of the recoil starter 10 according the present embodiment will be described.

Before the engine starts, the ratchet 14 is in the retracted position, that is, retracted inwardly of the drive pulley 15.

When the recoil rope 13 is pulled in this state, the rope reel 12 is rotated, and the ratchet 14 is rotated together therewith. On the other hand, the control member 18 is not immediately rotated, since it is attached to the reel supporting unit 11a with predetermined rotational resistance. Thus, when the ratchet 14 is further rotated together with the rope reel 12, since the projection 14c is guided by the engaging groove 18a, the ratchet 14 is pivoted so that the front end portion 14b projects radial outward.

As the ratchet 14 is pivoted, the front end portion 14b projects radial outward and is inserted into the engagement portion 15a of the drive pulley 15. And, the pivoting movement of the ratchet 14 is stopped after the front end portion 14b collides with the ratchet receiving unit 12c of the rope reel 12 so as to be stably supported by the ratchet receiving unit 12c. Then, since the drive pulley 15 rotates together with the rope reel 12 via the ratchet 14, the engine can be started.

When the recoil rope 13 is released after the engine starts, the rope reel 12 is rotated in the reverse direction by the urging force of the recoil spiral spring. As a result, the recoil rope 13 is rewound, and the ratchet 14 returns to the retracted position along the engaging groove 18a.

In the present embodiment, the reinforcing unit 12d bridges between the two facing ratchet receiving units 12c as shown in FIG. 5. The reinforcing unit 12d extends in the circumferential direction with respect to the ratchet receiving units 12c as its leg portions, and is provided to define a space S for allowing the pivoting movement of the ratchet 14. Since the reinforcing unit 12d reinforces the ratchet receiving units 12c on which a load is intensively imposed, deformation of the ratchet receiving units 12c can be effectively prevented.

In the present embodiment, a material for the rope reel 12 is not required to have a high rigidity, thereby reducing the material cost. When molding the rope reel 12, the space S between the two ratchet receiving units 12c may be defined by inserting a mold which is movable in the thickness direction of the rope reel 12 between the two ratchet receiving units 12c. As a result, the space S between the two ratchet receiving units 12c is opened on at least one side of the rope reel 12, thereby weakening the rope reel 12. Such opening could be avoided, but it requires, for example, a mold which is movable in the radial direction of the rope reel 12, thereby complicating the molding system and increasing the manufacturing cost. However, by providing the reinforcing unit 12d to bridge between the two facing ratchet receiving units 12c, the rope reel 12 can be structurally reinforced. Further, by arranging the reinforcing unit 12d on the other side of the rope reel 12, the mold for defining the space S is allowed to be removed in the thickness direction of the rope reel 12 from the opening formed on the one side of the rope reel 12, that is, the provision of the reinforcing unit 12d does not necessitate the mold which moves in the radial direction of the rope reel 12. Thus, the sufficient strength can be maintained while suppressing the material cost and the molding cost.

Further, the reinforcing unit 12d is formed to cover the front end portion 14b of the ratchet 14 projecting outward to contact the ratchet receiving unit 12c with a small gap. Thus, floating of the front end portion 14b of the ratchet 14 can be suppressed by the reinforcing unit 12d.

According to the present embodiment, the rope reel 12 includes the ratchet receiving units 12c arranged to receive the front end portion 14b of the ratchet 14 being inserted into the engagement portion 15a of the drive pulley 15, and the bridge-shaped reinforcing unit 12d formed on the ratchet receiving units 12c as its leg portions. Thus, the reinforcing unit 12d reinforces the ratchet receiving units 12c on which a load is imposed, thereby preventing deformation of the rope reel 12. Since the reinforcing unit 12d is formed continuously with the ratchet receiving units 12c, the rope reel 12 can be structurally simplified and can be reduced in weight.

Since the reinforcing unit 12d is formed to cover the front end portion 14b of the ratchet 14 projecting outward, floating of the front end portion 14b can be suppressed, and the ratchet 14 can be prevented from coming off the ratchet receiving unit 12c even when the rope reel 12 is deformed. Since this effect is achieved by the reinforcing unit 12d, it is unnecessary to provide another member arranged to suppress the floating, thereby simplifying the structure.

Since the ratchet receiving units 12c are provided in a line symmetry manner with respect to the reinforcing unit 12d, the recoil starter 10 can be applied to an engine regardless of its rotation direction by using either one of the ratchet receiving units 12c. Thus, it is unnecessary to manufacture two kinds of rope reels 12 for both rotation directions of engines, thereby reducing the manufacturing cost.

Although the above-described embodiment exemplifies a specific shape of the shape of the reinforcing unit 12d, any shape can be applied as long as the reinforcing unit 12d can increase the strength of the rope reel 12 with respect to the ratchet receiving units 12c as its leg portions. For example, the reinforcing unit 12d may be formed to have a dome shape in which a wall section is provided on the outer circumference side of the ratchet receiving units 12c in addition to the above-exemplified shape.

1. A recoil starter including:
a starter case (11);
a rope reel (12) attached rotatable to the starter case (11);
a recoil rope (13) wound around the rope reel (12);
a ratchet (14) pivotably attached to the rope reel (12); and
a drive pulley (15) connected to an engine, the drive pulley (15) having an engaged unit (15a) engageable with the ratchet (14),
wherein, when the rope reel is rotated by pulling the recoil rope (13), the ratchet (14) pivots to engage the engaged unit (15a) of the drive pulley (15) to thereby transmit a torque of the rope reel (12) to an engine, and
wherein the rope reel (12) has:
a ratchet receiving unit (12c) arranged to receive a front end portion (14b) of the ratchet (14) when it is engaged with the engaged unit (15a) of the drive pulley (15); and
a reinforcing unit (12d) that extends in a circumferential direction of the rope reel (12) with respect to the ratchet receiving unit as its leg portion.

2. The recoil starter of claim 1,
wherein the reinforcing unit (12d) is formed to cover the front end portion (14b) of the ratchet (14) when it contacts the ratchet receiving unit (12c) and to thereby suppress floating of the front end portion (14b) of the ratchet (14).

3. The recoil starter of claim 1,
wherein two ratchet receiving units (12c, 12c) are provided as the ratchet receiving unit (12c) in a line symmetry manner with respect to the reinforcing unit (12d).

4. The recoil starter of claim 3, further including:
a control member (18) attached to the starter case (11) concentrically with the rope reel (12),
wherein the ratchet (14) has a projection (14c), and the control member (18) has an engaging groove (18a) which receives the projection (14c) and which extends to guide a pivoting movement of the ratchet (14) to project radial outward, and
wherein two engaging grooves (18a) are provided as the engaging groove (18a) in a line symmetry manner.
